(19) United States
(12) Patent Application Publication
(10) Pub. No.: US 2002/0167404 A1
(43) Pub. Date: Nov. 14, 2002

(54) System and method for supplying goods and services

(76) Inventor: Robert B. Jordan IV, Mt. Gilead, NC (US)

Correspondence Address: COATS & BENNETT, PLLC, P O BOX 5, RALEIGH, NC, 27602, US

(21) Appl. No.: 09/851,515

(22) Filed: May 8, 2001

(51) Int. Cl. E05B 45/06

(52) U.S. Cl. 340/543

(57) ABSTRACT

The present invention is directed to a system and method of a single provider supplying goods and services to a group of households. These goods and services are supplied to each of the customers at a periodic basis over a period of time. A list of available goods and services is generated and distributed to a plurality of households within a geographic area and orders are received from the households. The goods are acquired from a plurality of different suppliers are periodically delivered to each of the households. While at the household, the provider may also perform the services indicated by the customer. This system and method provides for a single provider to get to know each of the customers and provide them with quality goods and services at a low cost and timely manner.

### BACKGROUND OF THE INVENTION

The present invention is directed to a method of providing goods and services to a plurality of households and, more particularly, to a system and method of establishing a network of households not to exceed a predetermined limit and supplying each with goods and services in a manner that takes advantage of economies of scale.

Many households experience busy work and personal schedules that do not allow time to perform basic tasks. These tasks include shopping for groceries, birthday presents, toys for the kids, clothes for members of the household, etc. Time is also not available for performing chores including waxing and washing the car, cleaning the gutters, cutting the grass, writing checks, balancing the checkbook, etc. Special events also occasionally occur that require time to plan and organize such as hosting a party, guests staying for a visit, vacations, among numerous others. In sum, there are numerous goods and services that are needed in everyday life in which persons are just too busy to perform.

Delivery service is currently available from grocery and department stores. The stores fill an order of goods in accordance with a list supplied by the user and may even deliver them to the user's house. Problems encountered with these delivery services are the user must be at their house at the time of delivery. If they are not home, the goods are left outside where they may be damaged or stolen. Additionally, these services only provide goods available at their stores. They are not capable of performing household services such as washing the car, cutting the grass, or paying the bills.

These services are also impersonal. The goods are acquired and delivered to the household exactly as indicated on the list. There is no logic performed on the part of the store personnel as they are usually not familiar with the individual household and do not know the members. Therefore, when an order for ten gallons of milk inadvertently gets included on the list, the household receives the milk even though they wanted one gallon of milk like they have received from the store for the last year.

Personnel such as maids, au pairs, and the like may be used and are charged with the duty of keeping the household stocked with goods and occasionally performing necessary services. These personnel are expensive and often not affordable except for wealthy households. Additionally, some persons do not want individuals in their homes especially when they are not at home for obvious safety and security reasons.

### SUMMARY OF THE INVENTION

The present invention is directed to a method and service of providing households with goods and services. A single supplier generates a list of goods and services that will be offered to a group of households. The list is distributed to the households and orders are received indicating the desired goods and services. The provider than obtains the goods that are desired by each of the households. By combined the needs of a number of households, the provider is able to buy in bulk and obtain less expensive prices than are otherwise available for individual purchases. Once the goods have been collected, the goods are delivered to the households on a periodic basis. The provider may deliver the goods daily, weekly, or monthly as indicated by the household. While at the household, desired services may also be performed. The services may range from manual jobs such as cutting the grass, to accounting functions such as balancing a checkbook and processing the household bills.

A delivery reception unit (DRU) may be installed at each of the households to which goods are delivered. The DRU may be a stand-alone structure that is located either adjacent to or connected with the home. The DRU may include refrigerator and freezers, ovens and heaters, dirty and clean clothes storage areas, a pet feeder, lockbox, and shelves. The provider is not required to enter the customer's home but rather deliver the goods to the DRU. The DRU is locked to ensure that the goods are safely stored within the interior to prevent damage or theft.

A limit is placed on the number of customers or amount of goods and services supplied from a single provider. The provider does not accept too many customers to ensure that existing customers are guaranteed quality and timely service. The network of customers that are serviced by a single provider may be limited by a predetermined geographic area, total amount of sales, total number of customers, or other predetermined measurement to ensure the provider is not overworked. New networks may be established in areas in which an overabundance of customers exist.

### BRIEF DESCRIPTION OF THE DRAWINGS

FIG. 1 is a flowchart illustrating the steps of one embodiment of the present invention;

FIG. 2A is a front view of a delivery reception unit constructed according to one embodiment of the present invention;

FIG. 2B is a schematic diagram illustrating the interior of a delivery reception unit constructed according to one embodiment of the present invention;

FIG. 3 is a schematic diagram illustrating the distribution of households and possible manners of limiting the number of customers serviced by a single provider;

FIG. 4 is a front view of an alternative embodiment of another delivery reception unit; and

FIG. 5 is a flowchart illustrating the steps of receiving new customer orders and placing the customers within a provider's network.

### DETAILED DESCRIPTION OF THE INVENTION

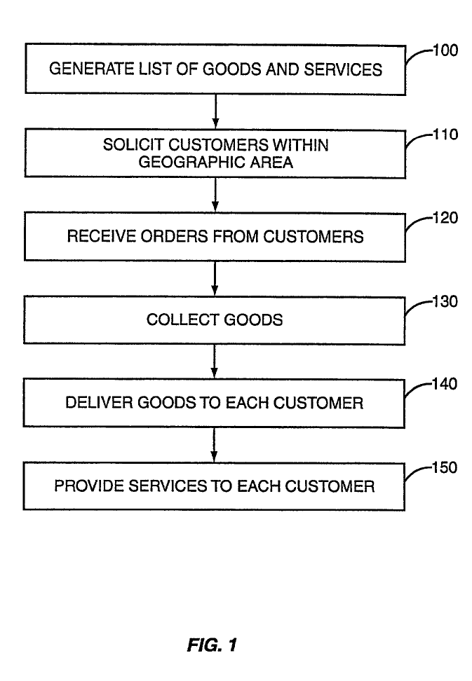

The present invention is directed to a system and method of a single provider supplying goods and services to a group of households. These goods and services are supplied to each of the customers on a periodic basis over a period of time. The method, illustrated schematically in FIG. 1, comprises generating a list of available goods and services (step 100) and soliciting a plurality of households within a geographic area (step 110). Orders are received from the households (step 120) and the goods are acquired from a plurality of different suppliers and may include a diverse range including food items, clothing, gifts for household members, etc. (step 130). On a periodic basis as indicated by each of the customers, the provider delivers the goods to each of the households (step 140). While at the household, the provider may also perform the services indicated by the customer (step 150). This system and method provides for a single provider to get to know each of the customers and provide them with quality goods and services at a low cost and timely manner.

The provider initially accumulates a list of goods and services that are offered to the customers (step 100). The goods may include food items such as milk, meat, bread, cereal, as well as specific meals that are served hot. Non-food items may further be included such as clothes, yard supplies, and household items such as shampoo, toothpaste, soap, and the like. In one embodiment, the goods are acquired from a plurality of different stores because they include a diverse array of items that cannot be located within a single store. Additionally, the stores used by the supplier may be chosen because of quality of the goods, price, or availability.

Services may include physical work including maintaining the appearance of the household such as cutting the grass, trimming the bushes, cleaning the pool, washing the car, etc. Services may also include administrative work including writing bills, balancing a checkbook, and calculating a household budget.

The list is distributed to a group of customers (step 110). In one embodiment, the list is distributed to persons within a specified geographic region. Other distribution systems include distributing the list to new home owners, households having children, etc. Distribution methods may include mailings, email messages, internet advertisements, television and radio commercials, and other means.

The provider may offer a variety of schedules that offer different goods and services. One schedule may contain a comprehensive list of goods and services that is more expensive but provides a much great variety of choices. By way of example, one schedule may include over 150 goods and more than 50 services. A second schedule may contain a truncated list of available goods and services at a lower price, such as only 50 goods and 10 services. Other schedules may also be available having a varying number of goods and services available with the costs associated for each also varying depending upon the schedule. In one embodiment, the first list is a master list that includes all the goods and services offered by the provider. The other less extensive lists contain goods and services that are included on the first list. Stated in another manner, the less extensive lists are subsets of the first list. This allows for basic goods and services which are needed by everyone to be available in each of the schedules. More unusual and less frequently used goods may only be available in a limited number of the schedules. Because of the overlap among goods which are common in each of the schedules, the provider is able to take advantage of economies of scale to obtain goods desired by a majority of the customers at a lower cost. The single source can purchase in bulk and spread the savings to the customers.

At the time a customer subscribes to the service (step 120), personal information about the household is obtained. The information may include birth dates of household members, names and ages of the persons residing at the dwelling, favorite sports teams, favorite schools and universities, and the like. This information allows the provider to learn more about the household and to purchase more personalized goods. Additionally, the information may spur the provider to offer additional goods and services that were not initially included. The provider can accumulate the orders from each of the customers and better determine goods and services that are in demand. The personal information may also be incorporated on a spreadsheet that is prepared for the customer to remind them of important dates and events that will affect them. By way of example, the provider may notify the customer that his or her spouse's birthday is coming up within a week and birthday gifts, cake, and other appropriate items should be purchased in preparation for this event.

At the time the orders are placed, the provider obtains each of the goods requested by the customers and accumulates them (step 130). In one embodiment, the provider accumulates the goods in a vehicle such as a truck or van. This eliminates unloading the goods at an accumulation point and then reloading them at the time of delivery.

On a periodic basis indicated by the customer, the provider delivers the goods to the household (step 140). This may be done on a daily, weekly, or monthly basis depending upon the desires of the customer. While at the household, the provider may also perform the indicated services (step 150). The services may be performed either using the customer's tools and equipment or the using the provider's tools and equipment. In the event the customer already owns the necessary tools such as a lawn mower or chainsaw, the provider simply uses this equipment to perform the desired services. This may allow the service provider to charge a lower cost. Alternatively, the provider may bring their own equipment to perform the services.

Customers may sign up for regular delivery of goods and services. This provides on a regular periodic basis such as daily, weekly, or monthly that the provider will bring the desired goods and perform the indicated services. By way of example, once a week, the provider may bring two gallons of milk, one loaf of bread, and a jar of peanut butter as well as cut the grass and trim the bushes.

Another plan is referred to as an Inventory Plan. Here, the customer identifies or lists certain goods and the quantity of goods that the customer desires to have on hand at all times. For example, the customer may want to have on hand at all times certain grocery items, such as milk, eggs, baby food, etc. The service provider will maintain an itemized list of the goods that the customer expects to be in inventory at all times. The itemized list will include a description of the items or goods and quantity to be maintained in inventory at all times. Thereafter, the service provider will make sure that the inventory is maintained. Specifically, the service provider will periodically visit the customer and review the inventoried goods on hand and re-stock the goods to make sure that, at substantially all times, the goods that the customer expects to be inventoried and on hand are indeed on hand. This plan or approach assures that the customer maintains a supply of specific goods.

A hybrid plan may also be available that combines the regular delivery plan and the inventory plan. The customer may have particular goods and services provided on the inventory plan during a part of the year, and then switch the goods and services to a regular deliver plan. By way of example, the customer may want their grass to always be mowed during the spring and summer months, but then only as requested during the fall and winter months. Likewise, the customer may always want a minimum amount of soda available during the summer, but only delivered as requested during other times of the year.

Customers are further able to determine the manner in which they will be billed by the provider. Payment may be made directly to the provider each time they visit the customer, or the customer may prefer a periodic billing period, such as the provider sending a monthly invoice for the goods and services provided.

Special orders for goods and services may also be received by the provider. These are additional items that are not normally supplied to the customer. The customer notifies the service provider either by a phone call, email, letter, or other predetermined method and indicates the necessary goods and/or services that are to be accomplished and the time frame in which they are needed. The provider will confirm that the goods and services can or can not be supplied by the desired time. Once a request is received from one of the customers, the provider may then send out an offer to other customers indicating the availability of the goods or services. This allows the provider to purchase goods in bulk to reduce the costs or to use equipment necessary for a special service at more than one customer's household. Goods and services may also be provided on a first-come, first-served basis. Examples include limousine service which may only be available to a single customer on a given date.

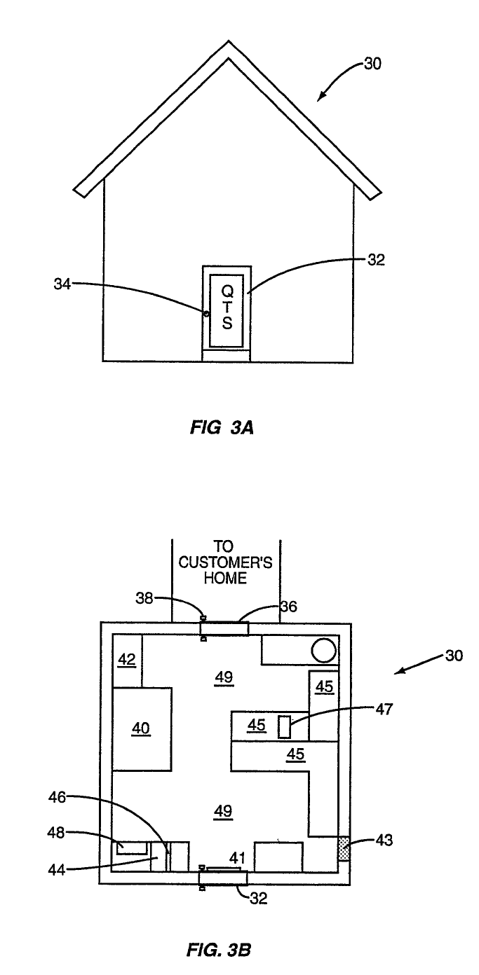

After a customer subscribes to receive goods, a delivery reception unit 30 (hereinafter DRU) is installed at the customer's dwelling. As illustrated in FIGS. 3A and 3B, the DRU 30 is a storage device to house the goods that are delivered to the customer. The DRU 30 allows the customer to receive and store numerous goods in an attractive, secure, and functional device without the provider entering the household. The customer then does not worry about persons being in their home, and it is not necessary for the customer to be at home at the time the goods are delivered.

As illustrated in FIG. 3A, the DRU 30 is an attractive, free standing storage facility that is positioned on the household property. The DRU 30 may have a variety of exteriors to match and blend with the existing house. The DRU 30 includes outer walls that form an interior space sized for the provider to enter and deliver the goods and the customer to enter and remove the goods as needed. At least one door 32 leads into the DRU through which the provider enters to deliver the goods. A lock 34 on the door 32 includes a combination or key that is given to both the provider and the customer such that the goods are secured when neither is at the household. A second door 36 having a second lock 38 may also be included for the customer to access the goods. In the embodiment in which the DRU 30 is positioned against the dwelling, the door 36 opens directly into the dwelling for the convenience of the customer. Because only the customer has the combination or key to the door 38, the customer is secure in knowing that the provider cannot enter the dwelling. The overall size and dimensions may vary depending upon the amount of goods the customer regularly orders and the schedule to which they subscribe. The DRU 30 may further include a ventilation system for heating and cooling the interior space.

FIG. 3B illustrates a schematic illustration of the interior of one embodiment of a DRU 30. A cold storage section 40 is sized to hold frozen and refrigerated goods. The cold storage section 40 may be divided to house frozen goods that are periodically delivered, refrigerated goods periodically delivered, and a special order section which can accommodate either frozen or refrigerated goods that are specially ordered by the customer.

A heated space 42 may be used for delivery of hot meals that are to be consumed by the customer soon after delivery. The heated space 42 may include an oven for maintaining the food at an increased temperature or may include an insulated area to maintain heat within already cooked and heated goods.

A laundry and dry cleaning section 44 is sized to contain hanging clothes and the general laundry receptacles. A bar 46 may be positioned within the section 44 on which clothes on hangars are stored. These clothes may be dirty and are to be picked up by the provider, or may dry-cleaned and returned by the provider for the customer. The section 44 further includes an area for storing general laundry that is washed in a washing machine and dryer. The section 44 may be sized to hold a plurality of containers 48 sized to hold clothes. The containers 48 are exchangeable and stackable such that a container of dirty clothes may be removed by the provider and replaced by those just cleaned.

A communication center 41 is allocated space for the customer to place orders with the provider. Communication center 41 may include slots sized to hold letters to be mailed, stamps, bills that are to be processed and paid by the provider from the customer's checking account, debit card, etc. Delivery lists can also be left at the communication center 41 along with other requests for goods and services.

An animal feeder 43 may be positioned within a wall of the DRU 30 for feeding the customer's pets. The feeder 43 is installed within one wall of the DRU and is sized to extend through the wall to the exterior. The provider may fill the feeder 43 and the pet has access to the food from the exterior of the DRU 30. The feeder 43 may further include a wall that can be placed over the opening in the wall when the feeder is not being used to prevent pests, insects, or the like from entering into the DRU 30.

Shelves 45 may throughout the DRU 30 to hold goods. The shelves may have a variety of sizes and strengths for accommodating a variety of goods. Shelves 45 may be placed adjacent to the pet feeder for holding excess food and other pet supplies such as flea items, heart pills, pet shampoo, etc. Additional shelves may be positioned to house non-food items such as clothing, personal hygiene products, and the like.

A lock box 47 may be used for storing money and checks. One service provided may include maintaining cash in specific denominations within the lock box 47. Additionally, a customer may place checks for payment to the provider or payment of the bills that are then processed by the provider.

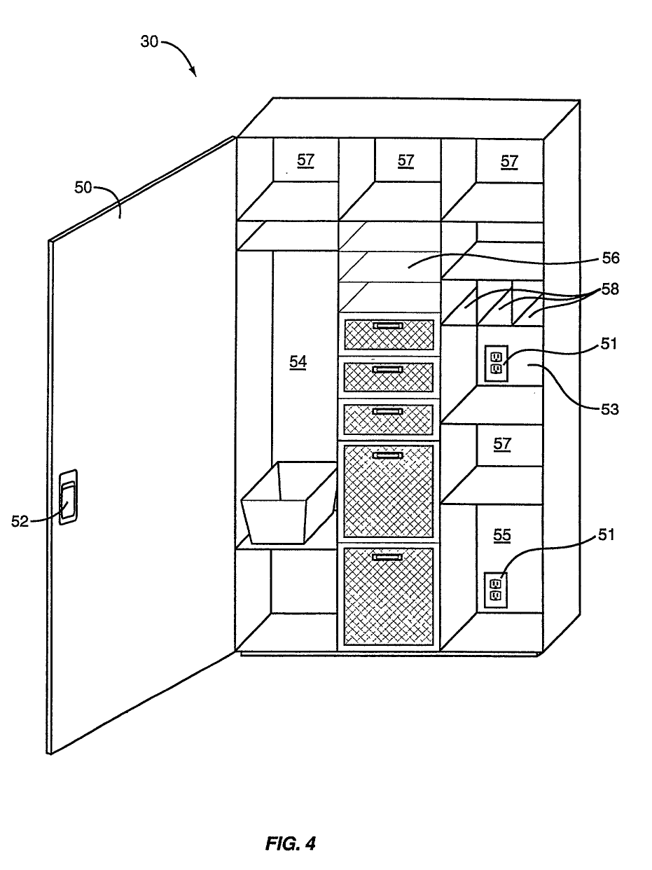

FIG. 4 illustrates an alternative embodiment of a DRU 30 that is smaller in size than that illustrated in FIGS. 3A and 3B. In one embodiment, the DRU 30 is about seven feet tall, two feet deep, and about 4 and one-half feet wide. The smaller size allows for this DRU 30 to be placed within the user's garage or house. Additionally, the smaller size may allow persons living in smaller dwellings to take advantage of the service, such as apartment dwellers who do not have space for the larger DRU 30 illustrated in FIGS. 3A and 3B.

DRU 30 includes a door 50 positioned on the front side and includes a lock 52 for securing the goods within the interior. The interior is divided into separate sections for housing a variety of different goods. Sections may include space 54 for clothes on hangars, such as dry cleaning, wine/liquor storage 56, valuable storage 58, heated meal storage 53, refrigerated/frozen storage 55, and a variety of different sized sections 57 for storing miscellaneous goods. Electrical outlets 51 may further be positioned about the interior for the user's convenience. The specific interior sections may further be lockable to prevent unwanted persons from accessing the goods stored within. By way of example, the wine/liquor storage area 56 and valuable goods storage 58 may have additional locks to prevent children or other unwanted persons from accessing the goods stored within.

A provider is able to service a limited number of customers. The maximum number of customers may be based upon customers living within a predetermined geographic area, sales exceeding a predetermined amount, or other quantifiable amount. Once a provider exceeds the maximum amount, new customers will either have to wait until an existing customer stops the service, or a new provider is established to meet the needs of the customers.

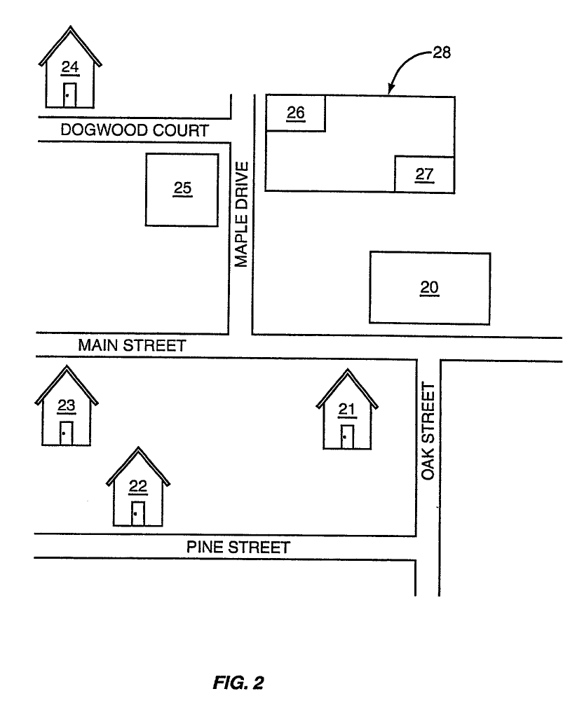

FIG. 2 illustrates a map of a geographic area. In one embodiment, a provider with a headquarters 20 may service only customers within a limited geographic area, such as to the south of Main Street, which includes customers 21, 22, and 23. In this embodiment, the provider is unable to service the additional customers located out of the geographic area including household 24, office building 25, and units 26 and 27 within apartment complex 28. An additional provider would need to be established for the additional households outside of the geographic area.

In another embodiment, provider 20 has a predetermined sales amount that controls the number of households that are serviced. Initially, households 24, 27, and 23 are serviced by the provider and the combined sales do not exceed the predetermined sales amount. Business office 25 then requests services for their location and are taken on as customers by the provider. Apartment unit 26 then requests service. However, since that amount would exceed the predetermined sales amount, the provider must deny service to the apartment unit 26. One skilled in the art will understand that there are a number of options for ensuring that the provider is not overworked and is able to provide quality and timely service to their customers.

The service provider visits the customers in a repeatable route that is followed on a regular basis. This allows the service provider to have a regular routine to ensure all customers are visited, and also allows the customer to know approximately when to expect the service provider. The service provider is also able to schedule the route in accordance with traffic cycles or other potential conflicts that may prevent on-time delivery.

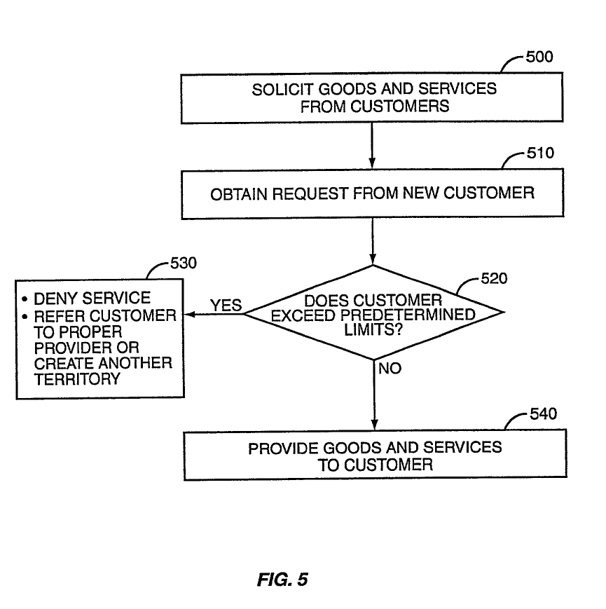

FIG. 5 illustrates the logic of one embodiment of establishing a network of customers for a provider. The list of available goods and services is distributed to potential customers within a region (step 500). Interested customers respond by requesting the desired goods and services (step 510). The provider then determines whether the new customer will exceed the established predetermined amounts (step 520). The predetermined amounts may include geographic area, total sales amounts, total number of customers, etc. If the customer does exceed the limit (step 530), the provider is not able to provide service. The provider may refer the customer to another provider who has capacity to accept the new work, or another network may be established with a new provider supplying the services. If the customer does not exceed the providers predetermined limits, the customer is accepted and the service is initiated (step 540).

The provider may be a single person or may be a group of persons. In either embodiment, it is preferred that the same person or persons continue providing service to a specific customer because they can become familiar with the customer's needs and provide better quality. This person learns the requirements of the individual customer. Additionally, the customer may become familiar with the person and appreciate the personalized attention.

In one embodiment, the goods and services are provided by a single person. At the time the person is delivering the goods, they may also perform any services that are desired by the customer. A single person plan reduces the number of trips that are made to the customer which saves driving time and fuel requirements, and reduces the intrusion on the customer. In another embodiment, the provider includes delivery personnel who deliver the goods to the customer and separate personnel to provide the services. These different personnel may visit the households at the same time, or may be on a different schedule.

A customer receives a deeded membership when they subscribe to the service. This membership may become valuable when because the number of customers is limited to the predetermined amount. Therefore, persons living within a specific area may not be able to obtain a membership if their provider is at their maximum capacity. The membership may have additional value since it may become in demand since only a limited number are available.

The provider may further include services for when the customer is away from their dwelling. These services may include providing pet care, picking up the mail and newspapers, water plants, and security checks to ensure the dwelling has not been vandalized or broken into by thieves. These additional services may require the provider to enter the customer's dwelling and would only be performed upon specific request by the customer.

The present invention may be carried out in other specific ways than those herein set forth without departing from the scope and essential characteristics of the invention. The customers may be provided with a computer system for ease in ordering goods and services. The computer system may be included within the DRU 30. The present embodiments are, therefore, to be considered in all respects as illustrative and not restrictive, and all changes coming within the meaning and equivalency range of the appended claims are intended to be embraced therein.

1. A method of supplying goods and services from a single provider to a plurality of households, said method comprising:
a) generating a list of goods and services to be offered by the single provider;
b) soliciting customers located within a geographic area that need the goods and services provided at their households;
c) receiving orders from the customers of the goods and services selected from the list;
d) collecting the goods that are to be delivered to each of the customers;
e) periodically delivering the goods selected to each of the customers; and
f) periodically providing the services selected to each of the customers.

2. The method of claim 1, wherein the step of collecting the goods that are to be delivered to each of the customers comprises the single provider obtaining the goods from a plurality of different suppliers and accumulating the goods at a location distant from the customers.

3. The method of claim 2, wherein the goods comprise food items.

4. The method of claim 3, wherein the goods further comprise non-food items.

5. The method of claim 1, wherein the step of the single provider periodically delivering the corresponding goods to each of the customers comprises delivering the goods on a daily basis.

6. The method of claim 5, wherein the step of the single provider periodically delivering the corresponding goods to each of the customers comprises delivering the goods on a weekly basis.

7. The method of claim 1, wherein a single employee of the single provider delivers goods and provides services to the customers.

8. The method of claim 1, further comprising installing an auxiliary building proximate to respective households, the step of delivering the goods to the customer comprises placing the goods within the auxiliary building.

9. The method of claim 1, further comprising one or more of the customers supplementing the list with additional goods and services and providing the additional goods and services to one or more of the customers.

10. The method of claim 9, further comprising offering the additional goods and services to all the customers.

11. The method of claim 1, further comprising limiting the number of customers serviced by the provider to a predetermined amount.

12. The method of claim 11, further comprising establishing a second provider after the number of customers desiring the goods and services exceeds the predetermined amount.

13. The method of claim 1, further comprising periodically supplementing the goods and services offered to the customers.

14. A delivery reception unit positioned proximate to a household for storing goods that are delivered to the household, the delivery reception unit comprising:
a) an interior space formed by an outer wall and being sized to store the goods and accommodate a person standing within;
b) a first door positioned within the outer wall to access the interior space, the first door having a first lock;
c) a second door positioned within the outer wall to access the interior space, the second door having a second lock;
d) a cold storage unit positioned within the interior space comprising a freezer section and a refrigerator section;
e) a heater unit positioned within the interior space;
f) a plurality of shelves connected to the outer wall to receive the goods; and
g) a lock box positioned within the interior section having a third lock.

15. The unit of claim 14, further comprising a walkway positioned within the interior space and extending between the first and second doors and being aligned to allow a person to place the goods within the cold storage unit, heater unit, lock box, and on the plurality of shelves.

16. The device of claim 14, further comprising a pet feeder positioned within the outer wall and having a first section positioned within the interior space to receive food and a second section integral with the first section and opening to an exterior of the outer wall for the food to be presented to a pet located outside the delivery reception unit.

17. The device of claim 14, further including a clothing storage unit having a rack on which to hang clothes.

18. The device of claim 14, further including a laundry receptacle positioned within the interior space, said laundry receptacle comprising at least one container for containing laundry.

19. The device of claim 14, wherein the delivery reception unit is attached to the household and the second door extends into an interior of the household.

20. The device of claim 14, further comprising a ventilation system to heat and cool the interior space.

21. A method of a single supplier providing goods and services to a group of customers, the method comprising:
a) generating a list of goods and services to be offered by the supplier;
b) obtaining an existing group comprising customers that periodically receive the goods and services;
c) receiving an order from a new customer requesting the supplier to provide the goods and services;
d) determining whether accepting the order results in exceeding a predetermined limit;
e) accepting the new customer when the order is within the predetermined limit; and
f) periodically delivering the goods and services requested by the new customer.

22. The method of claim 21, wherein the step of determining whether accepting the order results in exceeding the predetermined limit comprises determining whether a predetermined number of customers is exceeded.

23. The method of claim 21, wherein the step of determining whether accepting the order results in exceeding the predetermined limit comprises determining whether the new customer is within a predetermined geographic area.

24. The method of claim 21, wherein the step of determining whether accepting the order results in exceeding the predetermined limit comprises determining whether accepting the new customer will exceed a predetermined sales total.

25. The method of claim 21, further comprising creating a second supplier for customers after the predetermined limit has been exceeded.

26. A method of providing goods or services to a membership-based group of consumers comprising:
a. establishing a membership based group of consumers and limiting the number of consumers that make up the group, and
b. providing a delivery service to the members of the group including:
(i.) receiving orders for goods or services from the members of the group; and
(ii.) delivering the ordered goods and services to members of the group.

27. The method of claim 26 including limiting the membership-based group to a first geographical area.

28. The method of claim 27 including establishing at least one other membership-based group for providing delivery services thereto where the other membership-based group lies in geographical areas outside of the first geographical area.

29. A method of delivering goods to a customer's residence by a service provider comprising: establishing a list of goods to be maintained in inventory, the list of goods to be maintained in inventory including a description of the goods and the quantity of selected goods to be maintained in inventory; the service provider periodically checking the existing goods in inventory and the quantity of the existing goods in inventory and comparing the existing goods and the quantity of existing goods to the list of goods to be maintained in inventory; and the service provider periodically re-stocking the inventory such that the existing goods and the quantity of the existing goods are generally maintained at a level equal to the list of goods to be maintained in inventory.

30. A method of delivering goods to the residences of customers by a service provider comprising: establishing a membership base customer list wherein the customers are served by a service provider that delivers goods or services to a residence associated with the respective customers and wherein only customers that are a part of the membership are served; limiting the customer base to a selected geographic area; and designing routing through the geographic area such that in delivering goods or service to the membership base, the service provider will transport the goods or services along said routing.
